(19) United States
(12) Patent Application Publication
(10) Pub. No.: US 2025/0390948 A1
(43) Pub. Date: Dec. 25, 2025

(54) INFORMATION PROCESSING APPARATUS

(71) Applicant: NEC Corporation, Tokyo (JP)

(72) Inventors: Taichi NAKAMURA, Tokyo (JP); Megumi ETO, Tokyo (JP); Yusuke KINOSHITA, Tokyo (JP)

(73) Assignee: NEC Corporation, Tokyo (JP)

(21) Appl. No.: 19/234,455

(22) Filed: Jun. 11, 2025

(30) Foreign Application Priority Data
Jun. 21, 2024 (JP) 2024-100518

(51) Int. Cl. G06Q 40/04; G06Q 10/10

(52) U.S. Cl. CPC G06Q 40/04; G06Q 10/103

(57) ABSTRACT

An information processing system of the present disclosure includes: a receiving unit configured to receive question data representing a question related to carbon credit; and a generating unit configured to generate an answer corresponding to details of the question data based on base data including information on greenhouse gas or carbon credit, and output the answer.

This application is based upon and claims the benefit of priority from Japanese patent application No. 2024-100518, filed on Jun. 21, 2024, the disclosure of which is incorporated herein in its entirety by reference.

### TECHNICAL FIELD

The present disclosure relates to an information processing apparatus.

### BACKGROUND ART

Decarbonization is planned around the world, and “carbon credits” are issued and distributed for removing greenhouse gases from the atmosphere and preventing emission of greenhouse gases to the atmosphere. For example, a company that purchases carbon credits is allowed to emit greenhouse gases corresponding to the purchase amount. Therefore, companies consider procurement of carbon credits in accordance with their own businesses and policies. Moreover, a system that trades carbon credits is disclosed as described in Patent Literature 1.

### CITATION LIST

### Patent Literature

[Patent Literature 1] Japanese Unexamined Patent Application Publication No. JP-A 2023-026906

### SUMMARY OF INVENTION

### Technical Problem

However, there is a problem that it is difficult for one who wants to procure a carbon credit to determine procurement of a carbon credit.

Accordingly, an object of the present disclosure is to solve the abovementioned problem that it is difficult to determine procurement of a carbon credit.

### Solution to Problem

An information processing apparatus as an aspect of the present disclosure includes: a receiving unit configured to receive question data representing a question related to carbon credit; and a generating unit configured to generate an answer corresponding to details of the question data based on base data including information on greenhouse gas or carbon credit, and output the answer.

Further, an information processing system as an aspect of the present disclosure includes: a database configured to accumulate base data including information on greenhouse gas or carbon credit; a receiving unit configured to receive question data representing a question related to carbon credit; and a generating unit configured to generate an answer corresponding to details of the question data based on base data including information on greenhouse gas or carbon credit, and output the answer.

Further, an information processing method as an aspect of the present disclosure includes: receiving question data representing a question related to carbon credit; and generating an answer corresponding to details of the question data based on base data including information on greenhouse gas or carbon credit, and outputting the answer.

Further, a program as an aspect of the present disclosure includes instructions for causing an information processing apparatus to execute processes to: receive question data representing a question related to carbon credit; and generate an answer corresponding to details of the question data based on base data including information on greenhouse gas or carbon credit, and output the answer.

### Advantageous Effects of Invention

With the configurations as described above, the present disclosure can facilitate determination of procurement for one who wants to procure a carbon credit.

### BRIEF DESCRIPTION OF DRAWINGS

FIG. 1 is a block diagram showing a configuration of a data provision apparatus according to the present disclosure.

FIG. 2 is a diagram showing a state of processing by the data provision apparatus according to the present disclosure.

FIG. 3 is a flowchart showing processing operation of the data provision apparatus according to the present disclosure.

FIG. 4 is a block diagram showing a hardware configuration of an information processing system according to the present disclosure.

FIG. 5 is a block diagram showing a configuration of the information processing system according to the present disclosure.

### EXAMPLE EMBODIMENTS

### First Example Embodiment

A first example embodiment of the present disclosure will be described with reference to the drawings. The drawings may be related to any example embodiment.

A data provision apparatus 10 in the present disclosure provides data on greenhouse gases and carbon credits. As an example, the data provision apparatus 10 is used to collect information on greenhouse gases and carbon credits, for example, when a company procures carbon credits, and the data provision apparatus includes a function of receiving a question from a person in charge of a company, generating an answer to the question, and outputting the answer.

To be specific, the data provision apparatus 10 is configured with one or a plurality of information processing apparatuses each including an arithmetic logic unit and a memory unit. Then, an information processing terminal 30 operated by a person in charge of a company as described above is connected to the data provision apparatus 10 via a network. In this example embodiment, the information processing terminal 30 of a user company that is a company allowed to use the data provision apparatus 10 is connected to the data provision apparatus 10, and questions and answers are transmitted and received as will be described later.

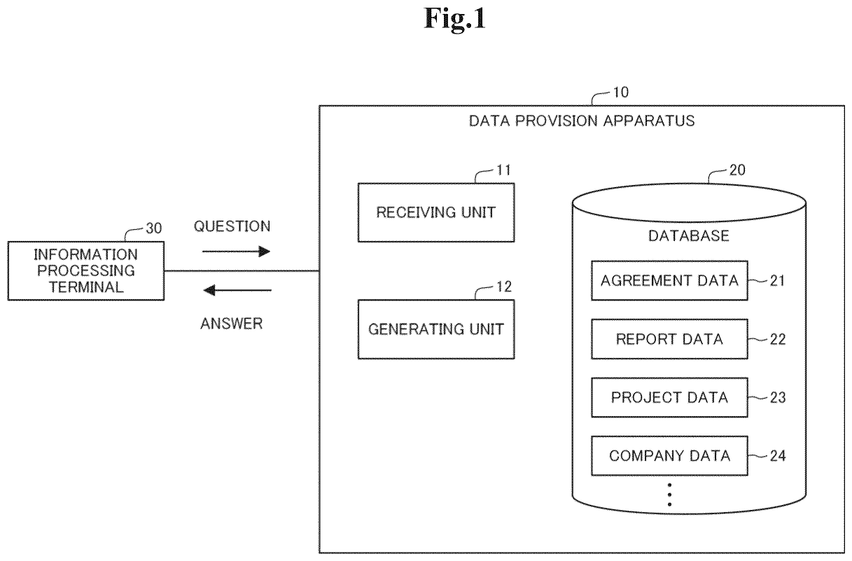

Then, the data provision apparatus 10 includes a receiving unit 11 and a generating unit 12 as shown in FIG. 1. The respective functions of the receiving unit 11 and the generating unit 12 can be implemented by execution of a program for implementing the respective functions stored in the memory unit by the arithmetic logic unit. Moreover, the data provision apparatus 10 includes a database 20 configured with the memory unit. The respective components will be described in detail below.

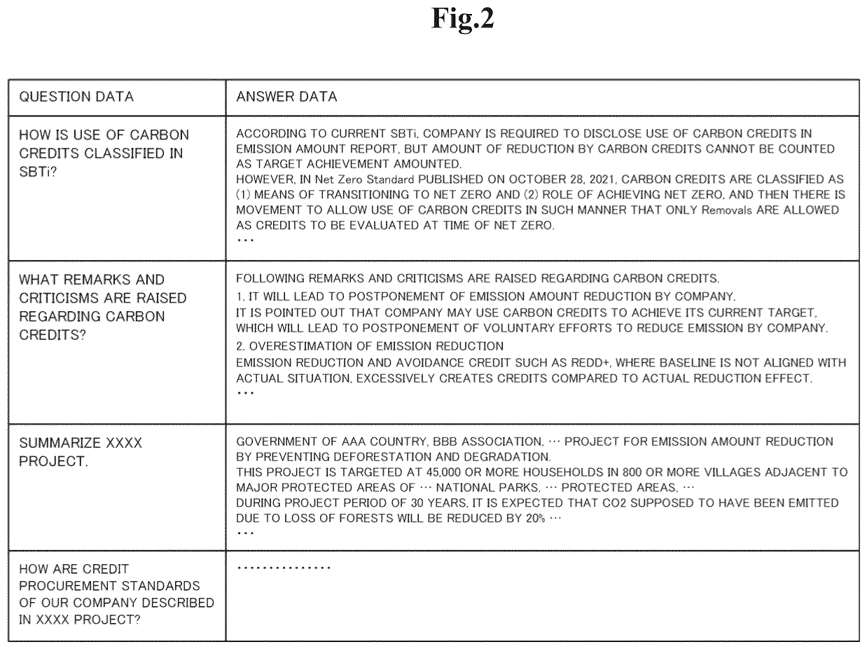

The database 20 stores and accumulates preset types of data (base data) related to greenhouse gases or carbon credits. Examples of types of data to be accumulated include agreement data 21, report data 22, project data 23 and company data 24 shown in FIG. 2. The agreement data 21 is data that includes the details of agreements concerning greenhouse gases and carbon credits, for example, laws and regulations of each country, guidelines and rules set by various organizations such as SBTi (Science-based Targets initiative), and the like. The report data 22 is data that includes the details of reports on greenhouse gases and carbon credits, for example, reports and news from an organization conducting a survey on the amounts of greenhouse gas emission and absorption and an organization evaluating corporate efforts to combat climate change, such as CDP (Carbon Disclosure Project) and TCFD (Task Force on Climate-related Financial Disclosures) The project data 23 is data that includes the details of a PDD (Project Design Document) on reduction of the amount of greenhouse gas emission, for example, data of each project design document itself and a monitoring report for each project. The company data 24 is data that includes the details of trends in companies concerning greenhouse gases and carbon credits, for example, the state of procurement of carbon credits by companies, procurement plans, management plans, various reports, and so forth. The company data 24 includes, in addition to the abovementioned data relating to the user companies, data relating to other companies different from the user companies.

The various data in the database 20 described above are acquired as necessary from an external device connected via the network by the data provision apparatus 10 and accumulated. Alternatively, the various data in the database 20 may be accumulated by being input from the information processing terminal 30 and other terminals into the data provision apparatus 10.

Further, the database 20 described above is not necessarily limited to being installed in the data provision apparatus 10. The database 20 may be configured with a storage device provided in an external device that is different from the data provision apparatus 10, and the database 20 and the data provision apparatus 10 may be connected via a cable or a network. In this case, the data provision apparatus 10 can access and use various data accumulated in the database 20 via the cable or the network as will be described below.

The receiving unit 11 receives question data representing a question composed of a sentence related to a carbon credit from the information processing terminal 30 operated by the person in charge of the user company described above. At this time, the details of the question data include, for example, a keyword related to the various data accumulated in the database 20 described above. Here, an example of the question data is shown in FIG. 2. As shown in the left column of this view, examples of the question data include “How is the use of carbon credits classified in the SBTi?”, “What remarks and criticisms are raised regarding carbon credits?”, “Summarize the XXXX project.” and “How is the credit procurement standards of our company described in the XXXX project?”. In this manner, the question data include keywords identifying agreements, reports, projects and companies accumulated in the database 20, and include requests for answers to such keywords. The question data listed in FIG. 2 is an example, and the question data may be of any details as long as the details of the question are related to carbon credits.

The generating unit 12 generates answer data composed of a sentence based on the data in the database 20 in accordance with the details of the question data received from the information processing terminal 30 as described above, and outputs it to the information processing terminal 30. That is to say, the generating unit 12 responds to the information processing terminal 30 in the interactive format, and generates and outputs answer data to the question data. For example, the generating unit 12 implements a sentence generation model trained by machine learning, and the sentence generation model uses the various data in the database 20 to create a sentence of answer data to be the details of an answer to the input question data. The sentence generation model is implemented as generative AI such as ChatGPT provided by OpenAI, Inc. of the United States and VertexAI provided by Google LCC of the United States, and it is possible to implement the generating unit 12 by using such techniques.

Here, an example of the answer data is shown in the right column of FIG. 2. First, in response to the question data “How is the use of carbon credits classified in the SBTi?”, answer data including what is specified in the SBTi guidelines is generated such as “According to the current SBTi, a company is required to disclose the use of carbon credits in the emission amount report. On the other hand, it is not possible to count the amount of reduction by carbon credits as the amount of target achievement. However, in the Net Zero Standard published on Oct. 28, 2021, there is a movement to allow carbon credits to be used, such as (1) means of transitioning to net zero and (2) role of achieving net zero, and then specifying that only Removals are allowed as credits to be evaluated at the time of net zero.” Moreover, in response to the question data “What kind of remarks and criticisms are raised regarding carbon credits?”, answer data including the details of remarks and criticisms as described in one report is generated, such as “The following remarks and criticisms are raised regarding carbon credits: 1. This will lead to a postponement in reducing companies' emissions.” Moreover, in response to the question data “Summarize the XXXX project”, answer data summarizing the details of the corresponding project is generated such as “Government of AAA country, BBB association, . . . project for emission amount reduction by prevention of deforestation and degradation. The project is . . . ”. Moreover, in response to the question data “How is the company's own credit procurement standards described in the XXXX project?”, answer data composed of a sentence is generated including the details described in the XXXX Project corresponding to the details of the credit procurement standards of the user company registered as the company data in the database 20.

The question data and the answer data may have the following details. For example, in response to question data “How is the latest trend in CDP and TCFD regarding carbon credits?”, answer data including the details of the latest version of the report and the details of comparison between the latest version and the previous version is generated, such as “In the latest version of CDP, οο is mentioned regarding carbon credits. XX has been changed compared to the previous version. Reference: XXYYZZ . . . ”. Moreover, in response to question data “What is the trend of other companies regarding carbon credits?”, answer data including news of efforts by other companies in the same industry as or different industries from the user company is generated.

Thus, the generating unit 12 generates answer data composed of sentences including the details of the various data accumulated in the database 20, that is, the data of agreements, reports, projects, companies and so forth so as to be an answer corresponding to the details of keywords and company data included in the question data. Meanwhile, the answer data shown in FIG. 2 is an example and is an answer to question data, and any question data may be provided as long as it uses the various data accumulated in the database 20.

### Operation

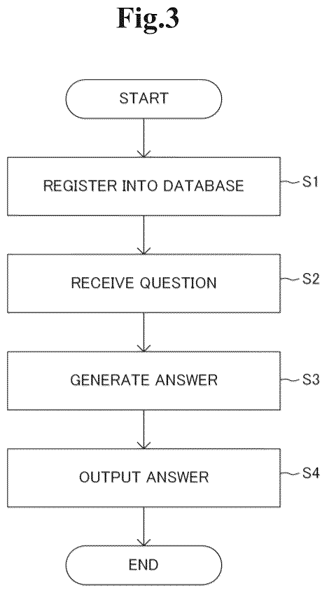

Next, the operation of the above data provision apparatus 10 will be described. First, the data provision apparatus 10 collects and receives input of various data such as the agreement data 21, the report data 22, the project data 23 and the company data as described above from an external device, and registers into the database 20 (step S1 of FIG. 3). It is preferable that the data provision apparatus 10 acquires the various data as necessary and stores the latest data.

Then, in a case where the user company collects information on carbon credits, for example, at the time of procuring carbon credits, the person in charge of the user company inputs question data into the information processing terminal 30 and transmits it to the data provision apparatus 10. Consequently, the data provision apparatus 10 receives the question data from the information processing terminal (step S2 of FIG. 3).

Then, the data provision apparatus 10 generates answer data composed of a sentence based on the data in the database 20 in accordance with the details of the received question data (step S3 of FIG. 3). For example, as shown in FIG. 2, the data provision apparatus generates answer data to be an answer responsive to the details of the question data. To be specific, the data provision apparatus 10 generates answer data composed of a sentence including the details of the various data accumulated in the database 20, that is, the data of agreements, reports, projects, companies and so forth so as to be an answer responsive to the details of keywords and company data included in the question data. Then, the data provision apparatus 10 transmits and outputs the generated answer data to the information processing terminal 30 (step S4 of FIG. 3).

Then, the person in charge of the user company can recognize the details of the answer data by outputting the answer data responsive to the question data, for example, displaying it on the display screen of the information processing terminal 30 or printing it on paper. Consequently, the user company can obtain the details to be an answer responsive to the question they have asked about carbon credits. As a result, the user company can obtain useful data that can be used for consideration of procurement of carbon credits, and can facilitate determination of procurement of carbon credits.

### Second Example Embodiment

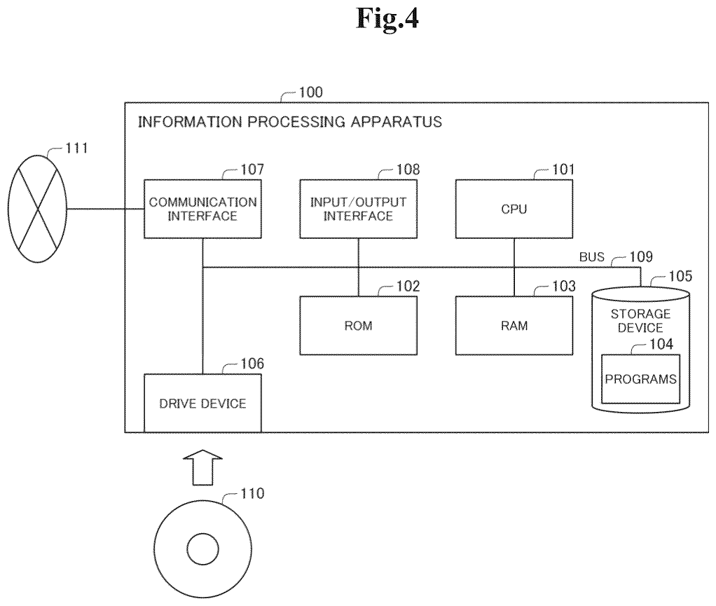

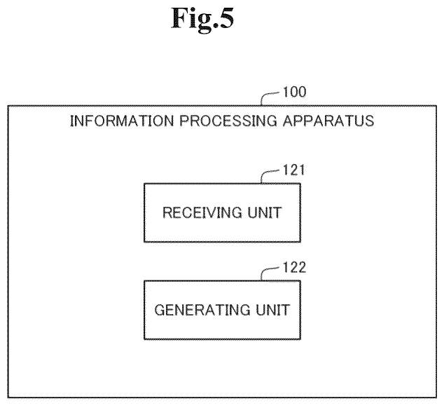

Next, a second example embodiment of the present disclosure will be described with reference to the drawings. This example embodiment shows the overview of the configuration of the data provision apparatus described in the above example embodiment. FIGS. 4 to 5 are views for describing the configuration, and such views may be related any of the example embodiments.

First, a hardware configuration of an information processing apparatus 100 will be described with reference to FIG. 4. The information processing apparatus 100 is configured with a general information processing apparatus and, as an example, has the following hardware configuration including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 4 shows an example of the hardware configuration of the information processing apparatus serving as the information processing apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

Then, the information processing apparatus 100 can construct and include a receiving unit 121 and a generating unit 122 shown in FIG. 5 by acquisition and execution of the programs 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the receiving unit 121 and the generating unit 122 described above may be constructed using dedicated electronic circuits for implementing such means.

The receiving unit 121 receives question data representing a question related to a carbon credit. The generating unit 122 generates and outputs an answer corresponding to the details of the question data based on base data including information on a greenhouse gas and a carbon credit.

Configured as described above, the present disclosure allows a company having asked a question on a carbon credit to obtain answer data to question data based on a variety of data on a carbon credit. Consequently, the company can obtain useful data that can be used for consideration of procurement of a carbon credit, and can facilitate determination of procurement of a carbon credit.

At least one or more functions of the receiving unit 121 and the generating unit 122 described above may be executed by an information processing apparatus installed and connected anywhere on the network, that is, may be executed by so-called cloud computing. For example, the information processing apparatus 100 described above may be configured with a first information processing apparatus equipped with the receiving unit 121 and the generating unit 122, and a second information processing apparatus that is connected to the first information processing apparatus via a cable or network and is equipped with a database accumulating base data including information on greenhouse gases or carbon credits.

Further, the abovementioned programs can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), read only memory (CD-ROM), CD-R, CD-R/W, semiconductor memory (e.g., mask ROM, programmable ROM, Erasable PROM, flash ROM, random access memory (RAM)). In addition, a program may be provided to a computer by various types of temporary computer-readable medium. Examples of temporary computer-readable medium include electrical signals, optical signals, and electromagnetic waves. The temporary computer-readable medium may provide a program to the computer via a wired communication channel, such as an electric wire and an optical fiber, or a wireless communication channel.

Although the present disclosure has been described above with reference to the above-described example embodiments, the present disclosure is not limited to the embodiments described above. The configuration and details of the present disclosure can be changed in a variety of ways that those skilled in the art can understand within the scope of the present disclosure. Then, each of the example embodiments described above can be combined with the other example embodiment as necessary.

### Supplementary Notes

The whole or part of the example embodiments disclosed above can be described as the following supplementary notes. Hereinafter, the overview of the configurations of an information processing apparatus, an information processing system, an information processing method, and a program in the present disclosure will be described. However, the present disclosure is not limited to the following configurations.

All or some of the configurations described in Supplementary Notes 2 to 7 dependent on Supplementary Note 1 below and the functions by such configurations may be dependent on other Supplementary Notes 8, 9, and 10 by the same dependence as Supplementary Notes 2 to 7. Furthermore, not limited to Supplementary Notes 1, 8, 9 and 10, within the scope of the example embodiments described above, some or all of the configurations described as supplementary notes and functions by such configurations may be dependent on hardware, software, various recording means for recording software, or system.

### (Supplementary Note 1)

An information processing apparatus comprising:

a receiving unit configured to receive question data representing a question related to carbon credit; and

a generating unit configured to generate an answer corresponding to details of the question data based on base data including information on greenhouse gas or carbon credit, and output the answer.

### (Supplementary Note 2)

The information processing apparatus according to supplementary note 1, wherein:

the base data includes agreement data including details of an agreement on greenhouse gas or carbon credit; and

the generating unit is configured to generate the answer including details of the agreement data in the base data in accordance with the details of the question data, and output the answer.

### (Supplementary Note 3)

The information processing apparatus according to supplementary note 1, wherein:

the base data includes report data including details of a report on greenhouse gas or carbon credit; and

the generating unit is configured to generate the answer including details of the report data in the base data in accordance with the details of the question data, and output the answer.

### (Supplementary Note 4)

The information processing apparatus according to supplementary note 1, wherein:

the base data includes project data including details of a greenhouse gas emission amount reduction project; and

the generating unit is configured to generate the answer including details of the project data in the base data in accordance with the details of the question data, and output the answer.

### (Supplementary Note 5)

The information processing apparatus according to supplementary note 1, wherein:

the base data includes company data including details of a company trend concerning greenhouse gas or carbon credit; and

the generating unit is configured to generate the answer including details of the company data in the base data in accordance with the details of the question data, and output the answer.

### (Supplementary Note 6)

The information processing apparatus according to supplementary note 5, wherein

the generating unit is configured to generate the answer including other data in the base data corresponding to the details of the company data in the base data in accordance with the details of the question data, and output the answer.

### (Supplementary Note 7)

The information processing apparatus according to supplementary note 1, wherein

the generating unit is configured to generate the answer corresponding to details of a keyword included by the answer data based on the base data, and output the answer.

### (Supplementary Note 8)

An information processing system comprising:

a database configured to accumulate base data including information on greenhouse gas or carbon credit;

a receiving unit configured to receive question data representing a question related to carbon credit; and

a generating unit configured to generate an answer corresponding to details of the question data based on the data in the database, and output the answer.

### (Supplementary Note 9)

An information processing method by an information processing apparatus, the method comprising:

receiving question data representing a question related to carbon credit; and

generating an answer corresponding to details of the question data based on base data including information on greenhouse gas or carbon credit, and outputting the answer.

### (Supplementary Note 10)

A program comprising instructions for causing an information processing apparatus to execute processes to:

receive question data representing a question related to carbon credit; and

generate an answer corresponding to details of the question data based on base data including information on greenhouse gas or carbon credit, and output the answer.

### REFERENCE SIGNS LIST

10 data provision apparatus
11 receiving unit
12 generating unit
20 database
21 agreement data
22 report data
23 project data
24 company data
30 information processing terminal
100 information processing system
101 CPU
102 ROM
103 RAM
104 programs
105 storage device
106 drive device
107 communication interface
108 input/output interface
109 bus
110 storage medium
111 communication network
121 receiving unit
122 generating unit

1. An information processing apparatus comprising:
at least one memory storing processing instructions; and
at least one processor configured to execute the processing instructions to:
receive question data representing a question related to carbon credit; and
generate an answer corresponding to details of the question data based on base data including information on greenhouse gas or carbon credit, and output the answer.

2. The information processing apparatus according to claim 1, wherein:
the base data includes agreement data including details of an agreement on greenhouse gas or carbon credit; and
the at least one processor is configured to execute the processing instructions to generate the answer including details of the agreement data in the base data in accordance with the details of the question data, and output the answer.

3. The information processing apparatus according to claim 1, wherein:
the base data includes report data including details of a report on greenhouse gas or carbon credit; and
the at least one processor is configured to generate the answer including details of the report data in the base data in accordance with the details of the question data, and output the answer.

4. The information processing apparatus according to claim 1, wherein:
the base data includes project data including details of a greenhouse gas emission amount reduction project; and
the at least one processor is configured to generate the answer including details of the project data in the base data in accordance with the details of the question data, and output the answer.

5. The information processing apparatus according to claim 1, wherein:
the base data includes company data including details of a company trend concerning greenhouse gas or carbon credit; and
the at least one processor is configured to generate the answer including details of the company data in the base data in accordance with the details of the question data, and output the answer.

6. The information processing apparatus according to claim 5, wherein the at least one processor is configured to generate the answer including other data in the base data corresponding to the details of the company data in the base data in accordance with the details of the question data, and output the answer.

7. The information processing apparatus according to claim 1, wherein the at least one processor is configured to generate the answer corresponding to details of a keyword included by the answer data based on the base data, and output the answer.

8. An information processing system comprising:
a database configured to accumulate base data including information on greenhouse gas or carbon credit; and
an information processing apparatus, wherein the information processing apparatus includes:
at least one memory storing processing instructions; and
at least one processor configured to execute the processing instructions to:
receive question data representing a question related to carbon credit; and
generate an answer corresponding to details of the question data based on the data in the database, and output the answer.

9. An information processing method by an information processing apparatus, the method comprising:
receiving question data representing a question related to carbon credit; and
generating an answer corresponding to details of the question data based on base data including information on greenhouse gas or carbon credit, and outputting the answer.

10. The information processing method according to claim 9, wherein the base data includes agreement data including details of an agreement on greenhouse gas or carbon credit, the method comprising generating the answer including details of the agreement data in the base data in accordance with the details of the question data, and outputting the answer.

11. The information processing method according to claim 9, wherein the base data includes report data including details of a report on greenhouse gas or carbon credit, the method comprising generating the answer including details of the report data in the base data in accordance with the details of the question data, and outputting the answer.

12. The information processing method according to claim 9, wherein the base data includes project data including details of a greenhouse gas emission amount reduction project, the method comprising generating the answer including details of the project data in the base data in accordance with the details of the question data, and outputting the answer.

13. The information processing method according to claim 9, wherein the base data includes company data including details of a company trend concerning greenhouse gas or carbon credit, the method comprising generating the answer including details of the company data in the base data in accordance with the details of the question data, and outputting the answer.

14. The information processing method according to claim 13, comprising generating the answer including other data in the base data corresponding to the details of the company data in the base data in accordance with the details of the question data, and outputting the answer.

15. The information processing method according to claim 9, comprising generating the answer corresponding to details of a keyword included by the answer data based on the base data, and outputting the answer.
